(19) United States
(12) Patent Application Publication
(10) Pub. No.: US 2015/0102072 A1
(43) Pub. Date: Apr. 16, 2015

(54) CONTAINER FOR LIQUID CHEMICALS

(71) Applicant: Holger Blum, Teufen (CH)

(72) Inventor: Holger Blum, Teufen (CH)

(21) Appl. No.: 14/572,777

(22) Filed: Dec. 17, 2014

Related U.S. Application Data
(62) Division of application No. 14/234,383, filed on Mar. 7, 2014.

(30) Foreign Application Priority Data
Jul. 22, 2011 (DE) 202011050795.5

(51) Int. Cl. B65D 1/16; B67D 7/78; B65D 25/28; B65D 1/20

(52) U.S. Cl. CPC B65D 1/165; B65D 1/20; B67D 7/78; B65D 25/2826
USPC 222/464.7; 222/481; 220/758; 222/182

(57) ABSTRACT

The invention relates to a container for liquid chemicals comprising a cylindrical container shell (4), an upper curved base (6) and a lower curved base (8) and also a container inflow (58, 60) and a container outflow (38, 42). The invention is characterized in that the container inflow (58, 60) and the container outflow (38, 42) are arranged at the upper curved base (6) of the container and in that a drainage tube (34) is provided which extends form the container outflow (38, 42) to the lower curved base (8).

### RELATED APPLICATIONS

The present application is a divisional application of U.S. patent application Ser. No. 14/234,383, filed on Mar. 7, 2014, which is a national phase of International Application No. PCT/EP2012/064327, filed on Jul. 20, 2012, which claims the benefit of priority to German Patent Application No. 202011050795.5, filed on Jul. 22, 2011, and the disclosures of which are hereby incorporated herein by reference in their entireties.

The invention relates to a container for liquid chemicals comprising a cylindrical shell, an upper curved base and a lower curved base as well as a container inflow and a container outflow.

The invention is based on the objective to provide a container for liquid chemicals in which the liquid chemicals can securely be transported and for this purpose, the container for liquid chemicals comprising a cylindrical container shell, an upper curved base and a lower curved base and also a container inflow and a container outflow, wherein the container inflow and the container outflow, are arranged at the upper curved base of the container, and a drainage tube is provided which extends from the container outflow to the lower curved base, is characterized in that a carrying ring is provided on the container wherein the carrying ring is connected to the container through mountings and surrounds the container inflow and the container outflow or the upper protective cover, respectively, with a distance.

The carrying ring again serves for the mechanical protection of the protective cover or the upper side of the container, respectively. On the other hand, the carrying ring forms a simple handling means for the container since the container may be gripped at the carrying ring and, thereafter, be transported. Finely, the carrying ring also serves the purpose to fix the container at a storage site at a wall, a post or the like thereby that a strap is simply put around the carrying ring.

An advantageous embodiment of the container of the invention is characterized in that the container inflow and the container outflow are embodied as inflow stubs and outflow stubs, respectively. The container of the invention is, thereby, arranged in an advantageous way such that the conduits for the inflow and the emptying of the liquid chemicals can be easily connected to the container.

A further advantageous embodiment of the container of the invention is characterized in that a shut-off valve is provided at the container inflow and the container outflow, respectively. Although valves for controlling the inflow and the outflow could be provided in the supply means for the container, it is advantageous when in the container inflow and the container outflow shut-off valves are provided because the operation of the container is possible, in this case, independent of the best preconditions of the filling device or the emptying device.

A further advantageous embodiment of the container of the invention is characterized in that an upper protective cover is provided which, in the mounted state, covers the container inflow and the container outflow. This protective cover serves, in an advantageous way, during transportation and storage of the container, for the protection of the armatures which are arranged at the upper side of the container. When the container is put into operation and the armatures have to be accessible, the protective cover can easily be taken off.

A further advantageous embodiment of the container of the invention is characterized in that the upper protective cover is connected to the container by means of a releasable strap connection wherein this is an advantageous and particularly simple solution for taking off the protective cover.

Further advantages, features and usage possibilities of the present invention are resulting from the following specification in connection with the embodiments shown in the drawings.

### BRIEF DESCRIPTION OF THE DRAWINGS

In the specification, in the claims and in the drawings, the terms as listed in the below list of the reference numbers and the respective reference numbers are used. In the drawings:

FIG. 1 shows a vertical section through the container of the invention;

FIG. 2 shows a view on to the upper side of the container of FIG. 1;

FIG. 3 shows a strap connection between the protective cover and the container;

FIG. 4 shows a side view of the container of the invention of FIG. 1, and

FIG. 5 shows a perspective view of the container according to the FIGS. 1 to 4.

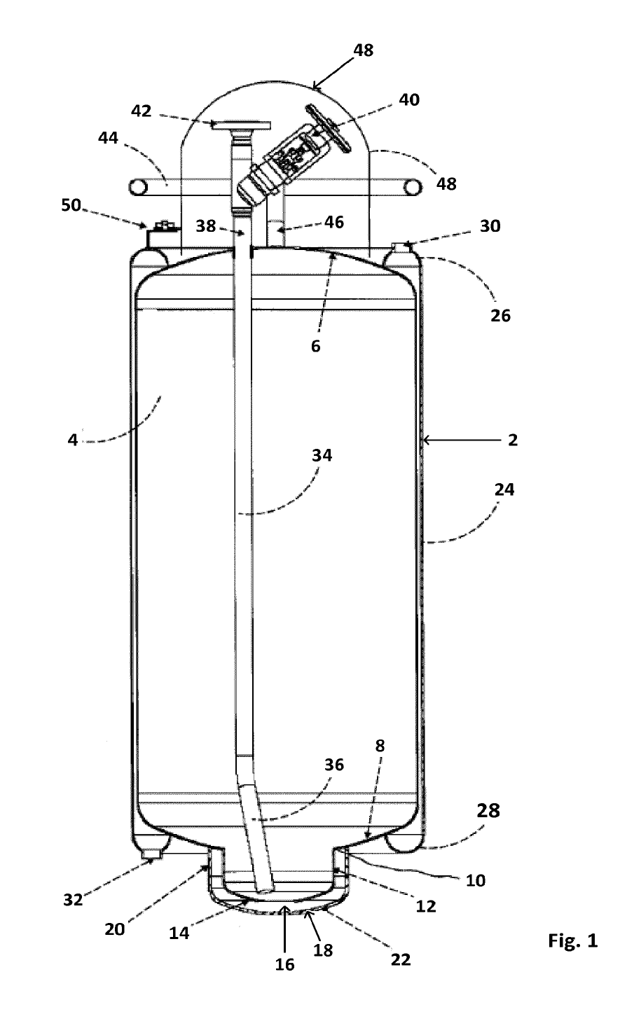

The container 2 of FIG. 1 consists out of metal and comprises a cylindrical shell 4 which is welded at the upper side to a curved base 6 and to the lower side with a curved base 8.

The lower curved base 8 has a central circular opening 10 into which a further cylindrical shell stub 12 is welded which, itself, is closed by means of a welded, curved bottom 14. The shell stub 12 and the bottom 14 form a bottom cup 16 in which the rests of the liquid chemical are collected upon drainage of the container. This arrangement is particularly advantageous when the container 2 is not in a completely vertical position during the drainage procedure.

The bottom cup 16 consisting out of the shell stub 12 and the bottom 14, is protected against a mechanical damage from outside by means of a protective cover 18 which consists out of shell stub 20 welded to the curved base 8 and out of a curved base 22 which is welded to the shell stub 20.

The cylindrical container shell 4 is protected against outer mechanical damage by means of an outer shell 24. The outer shell 24 is welded to ring tube halves 26 and 28. The ring tube half 26 is welded to upper curved base 6. The ring tube half 28 is welded to the lower curved base 8. By means of the arrangement with the ring tube halves 26 and 28, the outer shell 24 is situated without tension on the container 2.

The ring tube halves 26 and 28 furthermore protect the upper and lower curved bases 6 and 8 against mechanical damage from outside.

A screw socket is welded to the ring tube half 26 as a liquid outflow 30 to which a hose or a tube can be connected. To the ring tube half 28, a screw socket is welded as a liquid inflow 32 to which a hose or a tube may be connected.

The container 2 comprises a drainage conduit 34 out of metal eccentrically to its central axis. At the bottom of the drainage conduit 34, a tube piece 36 is welded in an oblique way. The tube piece 36 reaches almost to the bottom of the curved bottom 14 of the bottom cup 16.

The drainage conduit 34 is hydraulically connected, at its upper side, to the tube stub 38. The tube stub 38 is welded to the upper curved base 6. A valve 40 is welded to the tube stub 38. Preferably, the valve 40 does not comprise a gland but comprises a liquid tight bellows. A tube flange 42 is welded to the valve 40, wherein, in this way, a first armature is formed by which a removable, hydraulic connection of the container 2 to other armatures can be effected.

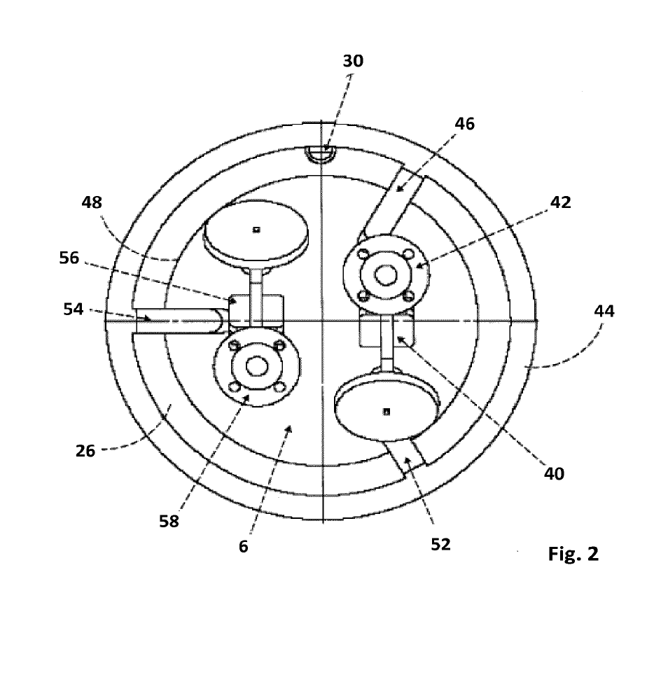

The container 2 comprises a carrying ring 44 which consist out of a circularly bent tube ring the outer diameter of the ring corresponding to the outer diameter of the cylindrical outer shell 24. The carrying ring 44 is connected to the upper curved base 6 by means of at least two mountings. In FIG. 1, a mounting 46 is visible. From FIG. 2, two further mountings as 52 and 54 are visible.

The container 2 comprises, for the protection of the flange stubs and the armatures, an upper protective cover 48 which is connected to the upper ring tube half 26 by means of two removable straps 50. At the side of drainage, the fixing nut 68 of each strap connection is loosened whereby the upper protective cover 48 may easily be removed and the access to the flange 42 is allowed.

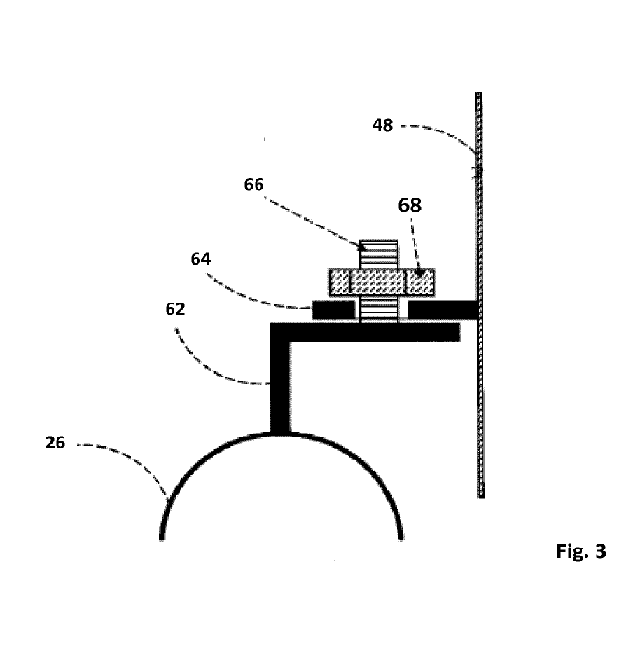

The details of the strap connection 50 can be taken from FIG. 3. Accordingly, the strap connection consists out of a sheet steel angle 62 which is welded to the ring tube half 26 as well as out of an eye 64 which is welded to the outer wall of the upper protective cover 48. During transportation of the container, the steel sheet angle 62 and the eye 64 are fixed to each other by means of the screw stub 66 welded to the steel sheet angle 62 and by means of the fixing nut 68.

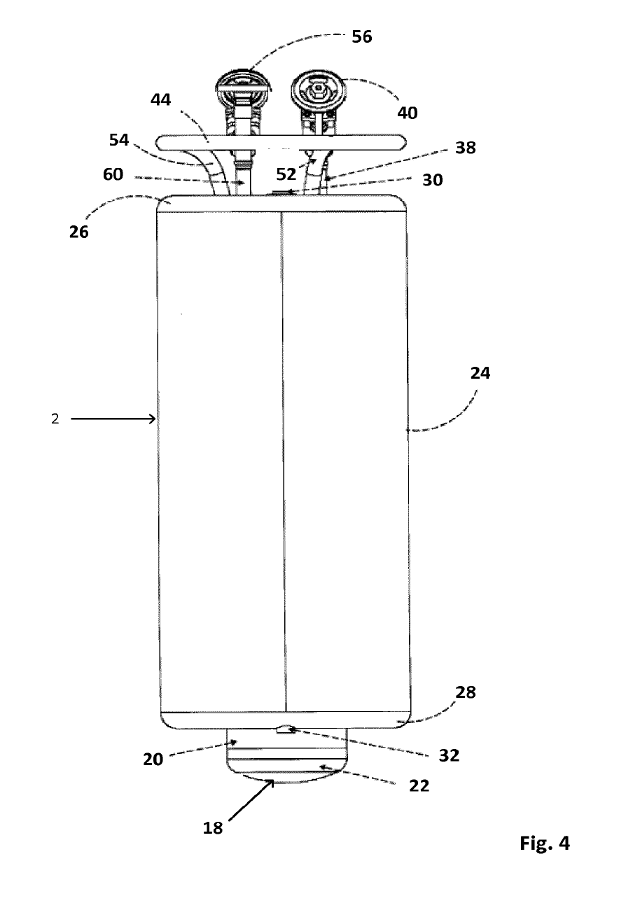

A second armature is arranged at the upper curved base 6 of the container 2 whereby the filling of the container is facilitated. As can be seen from FIG. 4, the armature consists out of a connection flange 58 on to which the valve 56 is welded. The valve 56 is without gland and is arranged as a bellows valve. As can be seen from FIG. 4, the valve 56 is hydraulically connected to the tube stub 60 welded to the upper curved base 6.

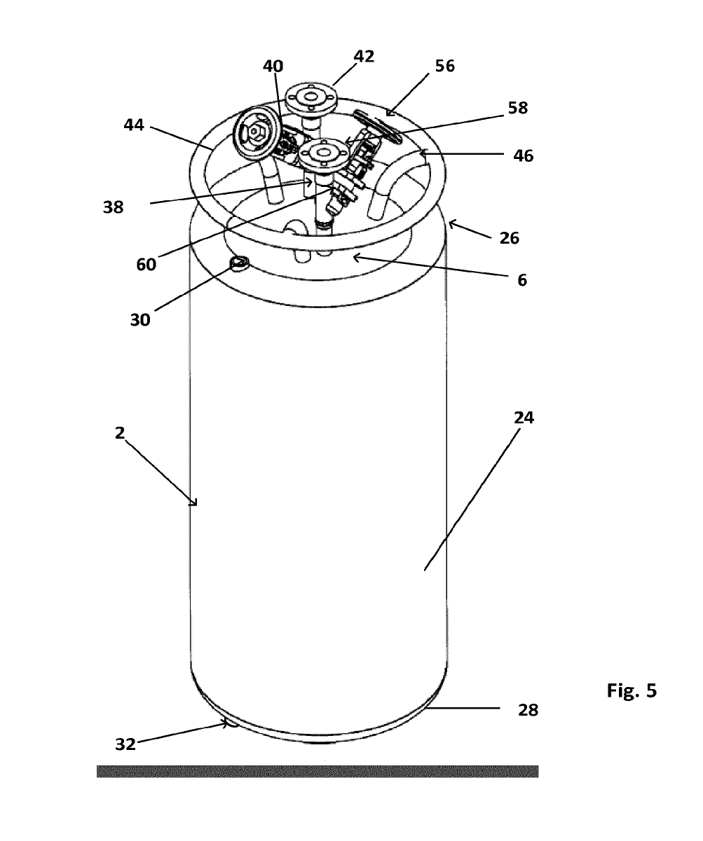

FIG. 5 shows in perspective view the arrangement of the valves 40 and 46 as well as the flanges 42 and 58 at the upper curved base 6 of the container 2.

### List of References

2 Container
4 Cylindrical container shell
6 Upper curved base of the container
8 Lower curved base of the container
10 Opening
12 Cylindrical shell of the bottom cup
14 Curved bottom of the bottom cup
16 Bottom cup
18 Protective cover
20 Shell of the lower protective cup
22 Curved bottom of the lower protective cover
24 Cylindrical outer shell
26 Upper ring tube half for the outer shell
28 Lower ring tube half for the outer shell
30 Outflow stub
32 Inflow stub
34 Drainage tube conduit
36 Tube piece
38 Tube stub
40 Valve
42 Flange
44 Carrying ring
46 Holder for carrying ring
48 Upper protective cover
50 Removable strap connection
52 Holder for carrying ring
54 Holder for carrying ring
56 Valve
58 Flange
60 Tube stub
62 Steel sheet angle
64 Eye
66 Screw stub
68 Screw nut

1. Container for liquid chemicals comprising a cylindrical container shell, an upper curved base and a lower curved base and also a container inflow and a container outflow, wherein
the container inflow and the container outflow, are arranged at the upper curved base of the container, wherein
a drainage tube is provided which extends from the container outflow to the lower curved base, and wherein
a carrying ring is provided on the container wherein the carrying ring is connected to the container through mountings and surrounds the container inflow and the container outflow or the upper protective cover, respectively, with a distance.

2. Container according to claim 1, wherein the carrying ring consist out of a circularly bent tube ring the outer diameter of the ring corresponding to the outer diameter of the cylindrical outer shell.

3. Container according to claim 1, wherein the carrying ring is connected through at least two mountings to the upper base of the container.

4. Container according to claim 1, wherein the container inflow and the container outflow comprise an inflow tube stub and an outflow tube stub, respectively.

5. Container according to claim 4, wherein, at the container inflow and the container outflow a shut off valve each is provided.

6. Container according to claim 1, wherein an upper protective cover is provided which covers, in the mounted state, the container inflow and the container outflow.

7. Container according to claim 4, wherein the upper protective cover is connected to the container through a removable strap connection.
